(19) United States
(12) Patent Application Publication
(10) Pub. No.: US 2026/0211598 A1
(43) Pub. Date: Jul. 23, 2026

(54) NON-TRANSITORY COMPUTER READABLE STORAGE MEDIUM

(71) Applicant: BROTHER KOGYO KABUSHIKI KAISHA, Nagoya (JP)

(72) Inventors: Yoshito HOSOMIZO, Konan (JP); Kenju NARITA, Nagoya (JP); Airi EGUCHI, Ichinomiya (JP)

(21) Appl. No.: 19/567,929

(22) Filed: Mar. 16, 2026

Related U.S. Application Data
(63) Continuation of application No. PCT/JP2024/045152, filed on Dec. 20, 2024.

(30) Foreign Application Priority Data
Jan. 30, 2024 (JP) 2024-011789

(51) Int. Cl. G06F 3/12

(52) U.S. Cl. CPC G06F 3/1232; G06F 3/1205; G06F 3/1253

(57) ABSTRACT

A non-transitory computer readable storage medium storing a support program that is executable by a computer of an information processing device, corresponds to a printer connected to the information processing device, and supports a general-purpose printing program incorporated in an operating system. The general-purpose printing program and the support program are configured to cause the computer to receive a print setting for causing the printer to execute printing based on capability information indicating a capability of the printer. The support program causes the computer to execute a display process of displaying a predetermined screen allowing reception of an operation from a user via a user interface of the information processing device. The support program further causes the computer to execute a polling process of periodically acquiring the capability information from the printer when the predetermined screen is being displayed during the display process.

### REFERENCE TO RELATED APPLICATIONS

This is a continuation application of International Application No. PCT/JP 2024/045152 filed on Dec. 20, 2024, which claims priority from Japanese Patent Application No. 2024-011789 filed on Jan. 30, 2024. The entire contents of the aforementioned applications are incorporated herein by reference.

### BACKGROUND ART

In recent years, a technique has been put into practical use in which a printer is controlled by an OS-standard general-purpose printing program that is part of the operating system (OS), without using a printer driver provided by a printer vendor. With this technique, when the OS detects a printer, association with the OS-standard general-purpose printing program is performed, and thereafter, when a print instruction for the printer is received, the OS-standard general-purpose printing program generates print data without using the printer driver provided by the printer vendor, making it possible to print using the OS-standard general-purpose printing program.

For example, a related art discloses a technique related to an OS-standard general-purpose printing program. The related art discloses a support program that supports a general-purpose printing program, which, if capability dependent information based on capability information of a printer is cached at a timing when the printer is selected, reads the cached capability dependent information, and if the capability dependent information is not cached, acquires the capability information from the printer and caches the capability dependent information based on the acquired capability information.

The capability of the printer changes depending on the status of the printer, such as attachment and detachment of additional trays. For this reason, if the capability information of the printer is acquired when the printer is selected, data based on the capability information is cached, and then the cached capability information is used as in the configuration of the related art, a current capability of the printer may not be accommodated.

### SUMMARY

A non-transitory computer readable storage medium storing a support program, for solving the above-described problems, the support program is executable by a computer of an information processing device, corresponds to a printer connected to the information processing device, and supports a general-purpose printing program incorporated in an operating system of the information processing device. The general-purpose printing program and the support program are configured to cause the computer to receive a print setting for causing the printer to execute printing based on capability information indicating a capability of the printer. The support program causes the computer to execute a display process of displaying a predetermined screen allowing reception of an operation from a user via a user interface of the information processing device. The support program further causes the computer to execute a polling process of periodically acquiring the capability information from the printer when the predetermined screen is being displayed during the display process.

### BRIEF DESCRIPTION OF THE DRAWINGS

FIG. 1 is a block diagram showing an outline of an electrical configuration of a PC.

FIG. 2 is a sequence diagram showing an example of a print setting procedure.

FIG. 3 is a sequence diagram showing an example of the print setting procedure.

FIG. 4 is a diagram illustrating an example of a detailed setting screen.

FIG. 5 is a sequence diagram showing an example of the print setting procedure.

FIG. 6 is a sequence diagram showing an example of a printing execution procedure.

FIG. 7 is a diagram showing an example of a print preview screen.

### DESCRIPTION

Hereinafter, a personal computer (hereinafter, referred to as a “PC”) that uses a support program according to a first aspect will be described in detail with reference to the accompanying drawings. The present specification discloses a support program that runs on the PC.

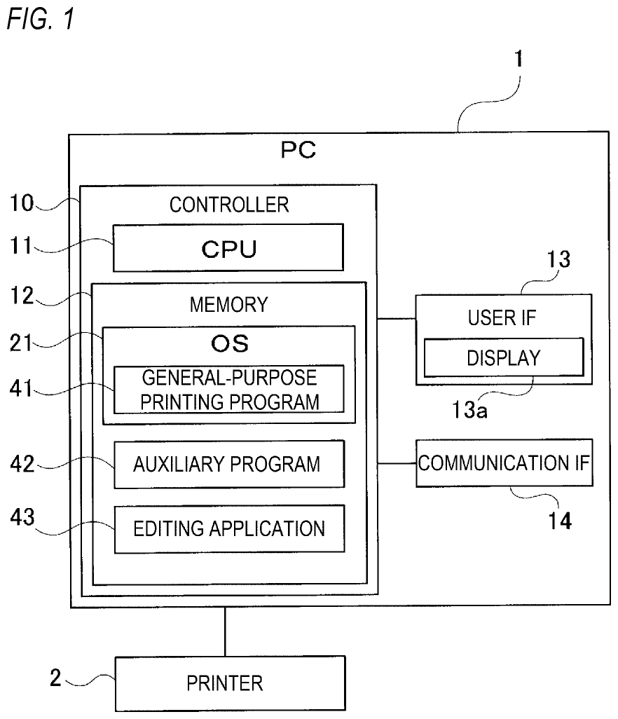

As illustrated in FIG. 1, a PC 1 according to the present aspect includes a controller 10 including a CPU 11 and a memory 12. The PC 1 is an example of the information processing device. The CPU 11 is an example of the computer. The PC 1 includes a user interface (hereinafter, referred to as a “user IF”) 13, and a communication interface (hereinafter, referred to as a “communication IF”) 14 that are electrically connected to the controller 10. The controller 10 in FIG. 1 is a collective term for hardware and software used to control the PC 1, and does not necessarily represent a single piece of hardware actually present in the PC 1.

The CPU 11 of the PC 1 is configured to execute various types of processes, in accordance with a program read from the memory 12 and based on a user operation. The memory 12 stores various programs and various data. The memory 12 is used as a work area in a case where various types of processes are executed. A buffer provided in the CPU 11 is also an example of the memory. An example of the memory 12 is not limited to a ROM, a RAM, a HDD, and the like built into the PC 1, but may also be a storage medium that can be read and written by the CPU 11, for example, a recording medium such as a CD-ROM, and a DVD-ROM.

The user IF 13 includes a display 13a which is hardware that displays a screen for reporting information to a user, and hardware that receives an operation from the user. The user IF 13 may be a combination of the display 13a capable of displaying information and a mouse, a keyboard, or the like having an input receiving function, or may be a touch panel having the functions of the display 13a and the input receiving function.

The communication IF 14 includes hardware for communicating with an external device such as a printer 2. Communication standards of the communication IF 14 include Ethernet (registered trademark), Wi-Fi (registered trademark), USB, and the like. The PC 1 may be connectable to the Internet via the communication IF 14. The PC 1 may include a plurality of communication IFs 14 corresponding to a plurality of communication standards.

As shown in FIG. 1, the memory 12 of the PC 1 stores various programs and various data including an operating system (hereinafter, referred to as “OS”) 21 including a general-purpose printing program 41, an auxiliary program 42, and an editing application 43. The auxiliary program 42 is an example of the support program.

The OS 21 is a multitasking OS that can process a plurality of tasks in parallel by managing and switching between the plurality of tasks. The OS 21 is, for example, Windows (registered trademark), macOS (registered trademark), Linux (registered trademark), iOS (registered trademark), or Android (registered trademark).

The OS 21 includes the general-purpose printing program 41. The general-purpose printing program 41 is an OS-standard program prepared by a vendor of the OS 21 and provided as a part of the OS 21. That is, the PC 1 is equipped with the OS 21 having the general-purpose printing program 41. The general-purpose printing program 41 is not configured to use a printer driver specific to each printer.

The general-purpose printing program 41 is a program having a function of causing printers of a plurality of types of models respectively provided by a plurality of vendors to execute printing based on an instruction of a user. The general-purpose printing program 41 supports a general-purpose function that enable printing to be performed on many printers. Unlike a printer driver specific to each printer, the general-purpose printing program 41 does not support functions specific to each printer or printer driver, in particular, functions that require complex processes.

The general-purpose printing program 41 is a program that includes a function of receiving image data designated as a printing target by a print instruction output from various applications based on an instruction of a user, and generating intermediate data based on the image data. The intermediate data is, for example, XPS data. The general-purpose printing program 41 further has a function of generating print data in a format that can be used for printing on various printers, based on the intermediate data. The print data is, for example, PWG Raster data or PDF data. The general-purpose printing program 41 has a function of transmitting the generated print data to a printer designated as a device to execute printing, via a communication function of the OS 21.

The auxiliary program 42 is a program or a group of programs that executes processes based on an instruction from the OS 21 in conjunction with the process of the general-purpose printing program 41, and is a program that supports the control of target hardware. The auxiliary program 42 of the present aspect corresponds to a model of the printer 2 connected to the PC 1, and is provided by, for example, the vendor of the printer 2. The general-purpose printing program 41 activates the auxiliary program 42 compatible with the printer 2 when the printer 2 is selected as a device for executing printing, when an instruction for detailed print settings is received in a state where the printer 2 is selected, when an instruction for causing the printer 2 to execute printing is received, or the like. The auxiliary program 42 is called, for example, a print support application (abbreviated as PSA) or a hardware support application (abbreviated as HSA).

The auxiliary program 42 may be a combination of a plurality of programs each of which receives an execution command, or may be one single program that can execute different processes in response to commands. Further, the auxiliary program may be a program prepared for each type of printer by the vendor of the printer. For example, an auxiliary program for an inkjet printer and an auxiliary program for a laser printer may be prepared separately. The auxiliary program may be prepared not only for each type of printer, but also for each model of printer or each series of printer models.

For example, when a new printer is connected to the PC 1, the OS 21 of the PC 1 can download an appropriate auxiliary program from a server or the like of the vendor of the printer or storage specified by OS 21 according to the type or model of the connected printer and incorporate the auxiliary program into the PC 1. The OS 21 stores identification information of the incorporated auxiliary program in the memory 12 in association with printer information of the newly connected printer.

The editing application 43 is, for example, a program for creating and editing image data and document data. The editing application 43 may be, for example, Microsoft Word (registered trademark) or PowerPoint (registered trademark) manufactured by Microsoft (registered trademark), or may be a program provided by the vendor of the printer 2. The editing application 43 can receive, via the user IF 13, a print execution instruction to cause the printer 2 to execute printing, for example. The editing application 43 is not limited to a program for creating or editing data, and may be a program that has a function of receiving a display instruction or a print instruction for various kinds of information such as map information or a web page in response to user requests.

The PC 1 of the present aspect is connected to the printer 2 via the communication IF 14 as shown in FIG. 1. The printer 2 is a device that has at least a printing function and a communication function. For example, when receiving print data from the PC 1 or the like, the printer 2 can execute printing based on the received print data. The printer 2 may be a device capable of color printing, or may be a device capable of only monochrome printing.

Next, the procedure of a process related to printing by the printer 2 in the PC 1 of the present aspect will be described. Each process other than the operation of a user in the present aspect basically indicates a process of the CPU 11 according to instructions written in a program such as the auxiliary program 42. In the present specification, various processes performed by the controller 10 or the CPU 11 according to programs such as the auxiliary program 42, the general-purpose printing program 41, and the OS 21 may be described as if each program were performing the various processes independently for convenience. The process executed by the CPU 11 also includes control of hardware using API of the OS 21. In the present specification, a detail description of the OS 21 is omitted, and an operation of each program is described. The term “acquisition” is used as a concept indicating that a request is not essential.

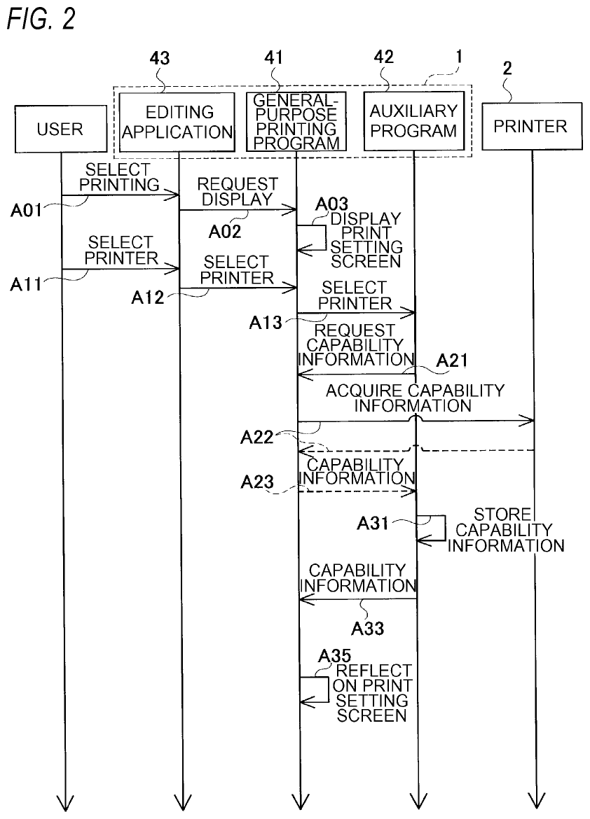

First, a print setting procedure for selecting a printer to be used for printing and receiving print settings will be described with reference to the sequence diagram of FIG. 2. The editing application 43 can create and edit text and images based on an instruction from the user. If the user intends to print a text or image being displayed, the user selects print in the editing application 43 (A01). The user can select print from a menu of operation items provided in the editing application 43, for example.

Upon receiving the selection of printing, the editing application 43 requests the general-purpose printing program 41 of the OS 21 to display a screen for receiving instructions regarding the printing (A02). In response to the request, the general-purpose printing program 41 displays a print setting screen on the user IF 13 (A03). The print setting screen is a screen that receives instructions from the user regarding various print settings that can be accepted by the general-purpose printing program 41. The print setting screen may be displayed by the editing application 43. The print setting screen may have a region where information specified by the auxiliary program can be displayed.

For example, in a case where a selection instruction to select the printer 2 as a device to execute printing is received on the print setting screen (A11), or in a case where selection of printing in A01 is received with the printer 2 selected as the device to execute printing, the editing application 43 passes information indicating that the printer 2 is selected to the general-purpose printing program 41 (A12). The general-purpose printing program 41 activates the auxiliary program 42 corresponding to the printer 2 and passes information indicating that the printer 2 has been selected (A13).

When the auxiliary program 42 is activated in response to the instruction from A13, the auxiliary program 42 acquires the capability information of the printer 2. Specifically, the auxiliary program 42 requests the general-purpose printing program 41 to acquire the capability information (A21). The general-purpose printing program 41 transmits a command requesting the capability information to the printer 2 and acquires the capability information from the printer 2 (A22). The general-purpose printing program 41 passes the acquired capability information to the auxiliary program 42 (A23). Accordingly, the auxiliary program 42 can acquire the capability information of the printer 2.

It is noted that the general-purpose printing program 41 performs communication with the printer 2 via the OS 21 in A22, for example, by communication according to internet printing protocol (IPP). Instead of making a request to the general-purpose printing program 41, the auxiliary program 42 may acquire the capability information directly from the printer 2 using, for example, a management information base (MIB). The capability information that the auxiliary program 42 can acquire from the printer 2 may include more information than the capability information acquired via the OS 21.

The capability information acquired from the printer 2 includes information on setting items that can be set as print settings and parameters that can be set for each setting item. The capability information includes, for example, information on items related to the sheet feeding trays and sheet discharging trays available to the printer 2, such as information indicating the selectable sheet feeding trays and sheet discharging trays, and sheet information such as the sheet size and sheet type of the sheet set in each sheet feeding tray. The capability information may further include information on the print resolution that printer 2 can support, information on the image processing function that printer 2 can execute, information indicating the status of printer 2 such as remaining amount of consumables, information indicating exclusive settings and how to resolve them, and information indicating default print settings. The capability information is used, for example, when the general-purpose printing program 41 or the editing application 43 displays a print setting screen or when determining an exclusive error in the print settings.

The auxiliary program 42 stores the acquired capability information in the memory 12 (A31). The auxiliary program 42 also passes the acquired capability information to the general-purpose printing program 41 (A33). The general-purpose printing program 41 reflects the capability information passed from the auxiliary program 42 on the print setting screen displayed in A03 (A35). For example, when capability information indicating that an additional tray is attached to the printer 2 is received, the general-purpose printing program 41 displays a print setting screen in which the additional tray is shown as an option. Furthermore, the general-purpose printing program 41 may store the capability information passed from the auxiliary program 42 in the memory 12, or may pass the capability information to the editing application 43 to share the capability information with the editing application 43.

The capability information stored in the memory 12 in A31 and the capability information passed to the general-purpose printing program 41 or editing application 43 in A33 may be information that includes all of the capability information acquired from the printer 2, or may be information that includes only part of the capability information acquired from the printer 2. For example, the capability information passed to the general-purpose printing program 41 or the editing application 43 may be only information about print settings that can be accepted by the general-purpose printing program 41 or the editing application 43.

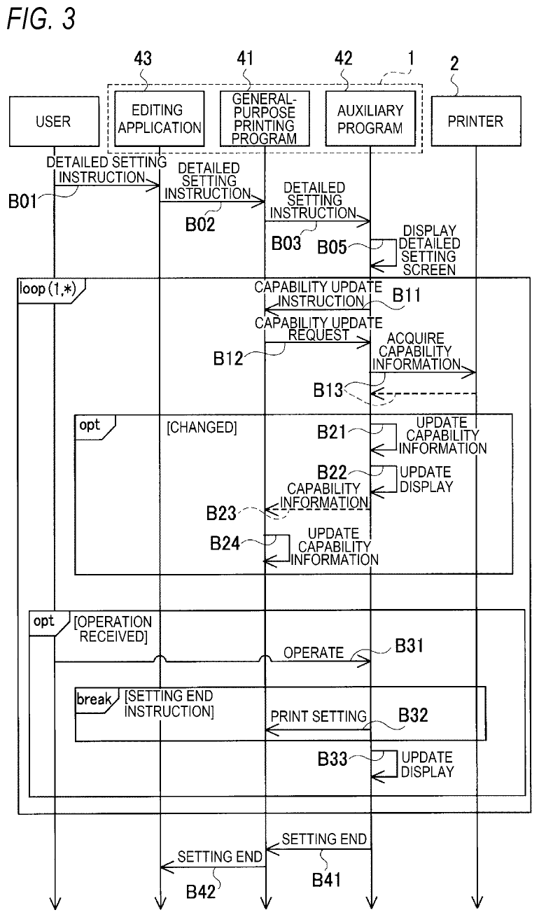

The user can operate the print setting screen being displayed to issue a detailed setting instruction to accept more detailed print settings related to printing by the printer 2, for example. A detailed setting procedure, which is the procedure when a detailed setting instruction from the user is received, will be described with reference to the sequence diagram of FIG. 3.

When an instruction for detailed print settings is received through a user operation (B01), the editing application 43 outputs the instruction for detailed settings, that is, an instruction to display a setting screen for receiving the detailed print settings, to the general-purpose printing program 41 (B02). The general-purpose printing program 41 activates the auxiliary program 42 corresponding to the printer 2 and passes an instruction to start receiving the detailed print settings (B03). In B03, the general-purpose printing program 41 passes information on the currently set print setting to the auxiliary program 42 along with an instruction to start the reception.

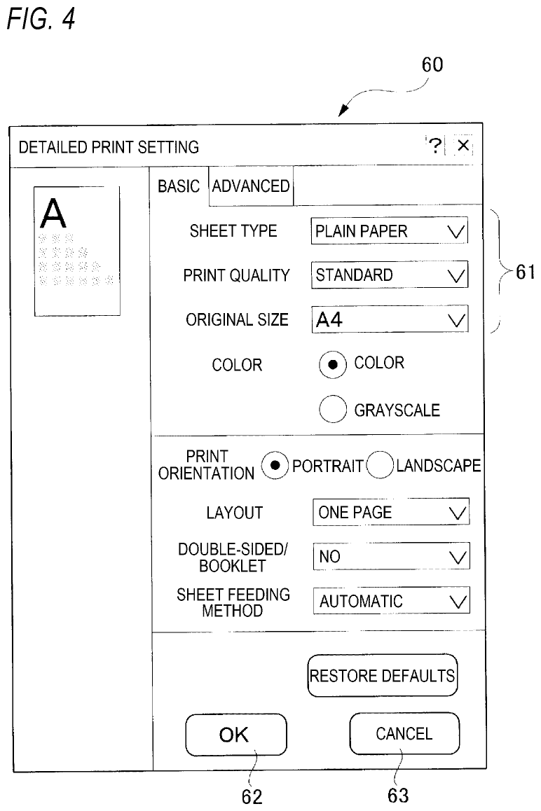

When the auxiliary program 42 is activated based on the instruction for detailed print settings, a detailed setting screen 60 is displayed on the user IF 13 (B05), as shown in FIG. 4, to receive a user operation. B05 is an example of the display process. The detailed setting screen 60 is an example of the print setting screen, and is an example of the predetermined screen. The instruction of B03 is also an instruction to display the detailed setting screen 60.

The detailed setting screen 60 displayed by the auxiliary program 42 includes, for example, a selection field 61 for receiving parameters for various print setting items, an “OK” button 62, and a “Cancel” button 63. The selection field 61 of the detailed setting screen 60 includes parameters that can be executed by the printer 2 as options. Since there are many print setting items that can be received on the detailed setting screen 60, the auxiliary program 42 may be able to receive an instruction to switch the items to be selected using a plurality of tabs, for example.

The auxiliary program 42 starts a procedure for updating the capability information stored in the memory 12 in a state where the detailed setting screen 60 is displayed. The auxiliary program 42 outputs a capability update instruction to the general-purpose printing program 41, for example, periodically and repeatedly (loop (1, *)) (B11).

When the general-purpose printing program 41 receives the capability update instruction, the general-purpose printing program 41 outputs a capability update request to the auxiliary program 42 (B12). The capability update request is an instruction from the general-purpose printing program 41 to the auxiliary program 42 requesting information for updating the capability information held in the general-purpose printing program 41. The auxiliary program 42 can receive a capability update request from the general-purpose printing program 41 by outputting the capability update instruction to the general-purpose printing program 41.

Upon receiving the capability update request, the auxiliary program 42 acquires the current capability information from the printer 2 (B13). The auxiliary program 42 may acquire the capability information by making a direct request to the printer 2, or may acquire the capability information via the general-purpose printing program 41 by making a request to the general-purpose printing program 41, as in A21 to A23 of FIG. 2. The auxiliary program 42 can periodically acquire the capability information from the printer 2 by periodically executing B11. The process of repeating B11 to B13 is an example of the polling process.

In B13, the auxiliary program 42 may acquire only a part of the capability information of the printer 2. Specifically, the auxiliary program 42 may request the capability information that includes only information related to the display of the detailed setting screen 60. Acquiring only a part of the information reduces the communication load as compared to acquiring all of the information.

The auxiliary program 42 compares the capability information stored in the memory 12 with the capability information acquired in B13, and determines whether the capability of the printer 2 has changed. The capability information stored in the memory 12 is, for example, the capability information stored in the memory 12 at A31 in FIG. 2 or B21, which will be described later.

If it is determined that the capability of the printer 2 has changed (opt: [changed]), the auxiliary program 42 updates and stores the capability information stored in the memory 12 (B21). B21 is a process for updating the capability information stored in the memory 12, and is an example of an update process. Further, the auxiliary program 42 updates the detailed setting screen 60 that is currently being displayed (B22). B22 is an example of the screen update process.

For example, if the sheet set in the sheet feeding tray is changed after the detailed setting screen 60 is displayed in B05, the parameters selectable in the selection field 61 may change. Further, for example, if the coloring materials for color printing run out and the color printing becomes impossible, the printer 2 may only accept a print instruction in which the color setting is set to monochrome printing. The auxiliary program 42 updates the detailed setting screen 60 based on the updated capability information, thereby displaying selectable parameters as options in response to changes in the capability of the printer 2.

Then, the auxiliary program 42 passes the capability information to the general-purpose printing program 41 based on the information acquired in B13 (B23). This allows the general-purpose printing program 41 to update the capability information indicating the capabilities of the printer 2, that is, the information received from the auxiliary program 42 in A33 of FIG. 2 and stored in the memory 12 (B24). B23 is a process for updating the capability information stored in the memory 12, and is an example of an update process.

If the currently acquired capability information has changed from the previously acquired capability information, the auxiliary program 42 causes the general-purpose printing program 41 to update the capability information of the printer 2. The auxiliary program 42 may instruct the general-purpose printing program 41 to update the capability information in B23. By updating the information held by the general-purpose printing program 41, options suitable for the updated capabilities of the printer 2 are displayed on the print setting screen displayed by the general-purpose printing program 41 or the editing application 43 thereafter.

On the other hand, the user can perform a setting operation for print settings on the detailed setting screen 60 that is being displayed. When the operation by the user is received (opt: [operation received], B31), the auxiliary program 42 determines whether the received operation is an operation to end the reception of print settings on the detailed setting screen 60. Specifically, when the auxiliary program 42 receives an operation on the “OK” button 62 or the “Cancel” button 63 on the detailed setting screen 60 (see FIG. 4), it is determined that the operation is an instruction to end the print setting.

When the instruction to end the print setting is received (break: [setting end instruction]), the auxiliary program 42 stops outputting the periodic capability update instruction (B11). Further, the auxiliary program 42 determines the print settings and passes information on the print settings to the general-purpose printing program 41 (B32). When an operation on the “OK” button 62 is received in B31, the auxiliary program 42 passes the information on the print settings being displayed to the general-purpose printing program 41. Further, when an operation on the “Cancel” button 63 is received, the auxiliary program 42 does not pass the information on the print settings received on the detailed setting screen 60 to the general-purpose printing program 41, and returns to the print setting before the detailed setting screen 60 is displayed.

Then, the auxiliary program 42 notifies the general-purpose printing program 41 of the end of the detailed settings (B41). The auxiliary program 42 may store information about the determined print settings in the memory 12. The general-purpose printing program 41 notifies the editing application 43 of the end of the detailed settings (B42). This allows the general-purpose printing program 41 and the editing application 43 to reflect the changed capabilities of printer 2 on the print setting screen displayed in A35 if the capabilities of printer 2 change after the printer 2 is selected.

If the user operation is not an instruction to end the print settings, the auxiliary program 42 updates the detailed setting screen 60 being displayed based on the user operation (B33), and then continues to output the periodic capability update instruction (B11). The auxiliary program 42 periodically repeats the output of B11 while the detailed setting screen 60 is displayed until an instruction to end the settings is received by a user operation. While the detailed setting screen 60 is displayed, the auxiliary program 42 waits for a period of time to receive an operation by the user. Further, while the detailed setting screen 60 is displayed, the print settings may be changed. The auxiliary program 42 periodically acquires the capability information of the printer 2 while the detailed setting screen 60 is displayed, and therefore can receive the print settings suitable for the latest capability information while reducing processing delays.

Regardless of whether the capability information has changed, the auxiliary program 42 may update the capability information of the general-purpose printing program 41 in response to the acquisition of the capability information. That is, the auxiliary program 42 may unconditionally execute B21 to B24 after B13. In this way, it is not necessary to determine whether there is a change. On the other hand, if B21 to B24 are executed only when there is a change, the number of times the contents of the memory 12 require to be updated can be reduced.

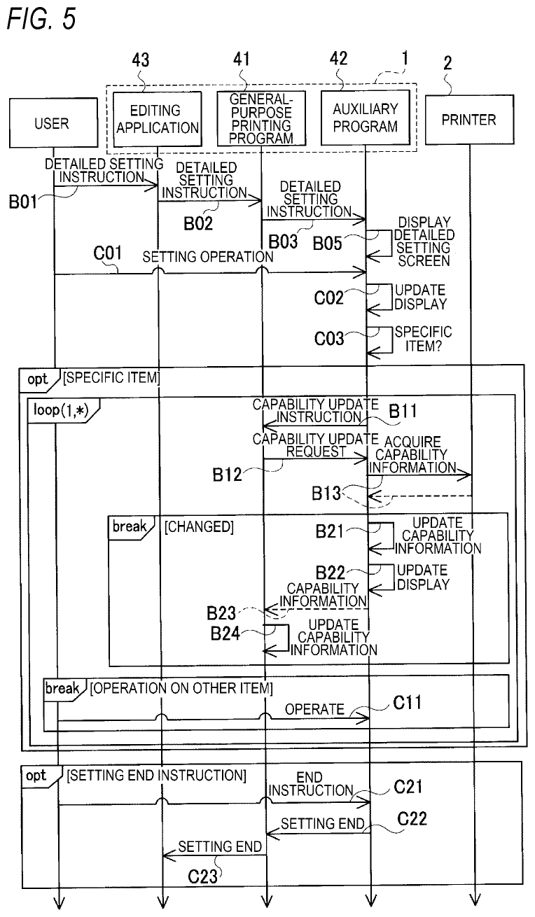

Further, instead of starting to output a capability update instruction when the detailed setting screen 60 is displayed, the auxiliary program 42 may start to output a capability update instruction when the user operation received on the detailed setting screen 60 being displayed is an operation on a specific item, for example, as shown in the sequence diagram of FIG. 5. The specific item is an item in which selectable options change when the capability of the printer 2 changes, and is, for example, a sheet feeding tray, a sheet discharging tray, a sheet size, a sheet type, or a color setting. In FIG. 5, the same steps as those in FIG. 3 are denoted by the same reference numerals and will be briefly described.

When the auxiliary program 42 receives an operation on the selection field 61 of the detailed setting screen 60 (see FIG. 4) displayed in B05 (C01), the auxiliary program 42 updates the display based on the operation (C02), and further determines whether the received operation is a change operation to a specific item (C03).

If it is determined that a change operation to a specific item is received (opt: [specific item]), the auxiliary program 42 starts a procedure for updating the capability information stored in the memory 12. The auxiliary program 42, for example, periodically repeats (loop (1, *)), outputs a capability update instruction to the general-purpose printing program 41 (B11), receives a capability update request (B12), and acquires the capability information of the printer 2 (B13). In this case, the process of repeating B11 to B13 is also an example of the polling process. The frequency with which B11 is performed may be different from that of the procedure of FIG. 3.

For example, in a case where a user wants to print on a sheet other than the sheet set in the sheet feeding tray, the user may change the sheet set in the sheet feeding tray and then select information on the changed sheet as the print settings. Alternatively, the user may change the sheet set in the printer 2 after changing the print settings for the sheet that is to be set. That is, when an instruction to change the settings related to the sheet feeding tray or sheet in the print settings is received, the capability of the printer 2 is changed or may be changed.

The auxiliary program 42 compares the capability information acquired in B13 with the capability information stored in the memory 12, and if it is determined that the capability of the printer 2 is changed (break: [changed]), the auxiliary program 42 stops outputting the periodic capability update instruction (B11), and updates and stores the capability information stored in the memory 12 (B21). Further, the auxiliary program 42 updates the detailed setting screen 60 that is currently being displayed (B22). B22 is an example of the screen update process. Further, the auxiliary program 42 passes the capability information to the general-purpose printing program 41 (B23), and the general-purpose printing program 41 updates the capability information indicating the capability of the printer 2 (B24).

When a change operation is performed on a specific item, the capability of the printer 2 is highly likely to change, and therefore the auxiliary program 42 periodically outputs the capability update instruction, so there is a high possibility that a change in the capability of the printer 2 can be accommodated. If the capability information is changed, it can be assumed that the user's work on the printer 2 is completed, and thereafter the state of the printer is less likely to change. The auxiliary program 42 stops outputting the capability update instruction when the capability information is changed, so the processing load while the detailed setting screen 60 is displayed is small.

Further, if the user operation is an operation on an item other than the specific item, the possibility that the capability of the printer 2 changes is low. In this case, the auxiliary program 42 does not output the capability update instruction, so the processing load while the detailed setting screen 60 is displayed is small. Items other than the specific item include, for example, the number of copies to be printed and the layout.

Further, even after a change operation to the specific item, the capability of the printer 2 may not change. Even if the capability of the printer 2 has not changed, when an operation on an item other than the specific item is received (break: [operation on other item], C11), the auxiliary program 42 stops outputting the periodic capability update instruction (B11) and further receives a user operation. If an operation on another item is accepted, it is highly likely that the user instruction on the specific item has ended. Even after the operation on another item is received, when the change operation to the specific item is received again, the auxiliary program 42 may resume outputting the periodic capability update instruction (B11).

When the received user operation is an instruction to end the print setting (opt: [setting end instruction], C21), the auxiliary program 42 ends the reception of the print settings, passes information on the determined print setting to the general-purpose printing program 41, and notifies the general-purpose printing program 41 of the end of the detailed settings (C22). The general-purpose printing program 41 notifies the editing application 43 of the end of the detailed settings (C23). As a result, if the capability of the printer 2 is changed, the changed capability of the printer 2 can be reflected on the print setting screen displayed by the general-purpose printing program 41 or the editing application 43.

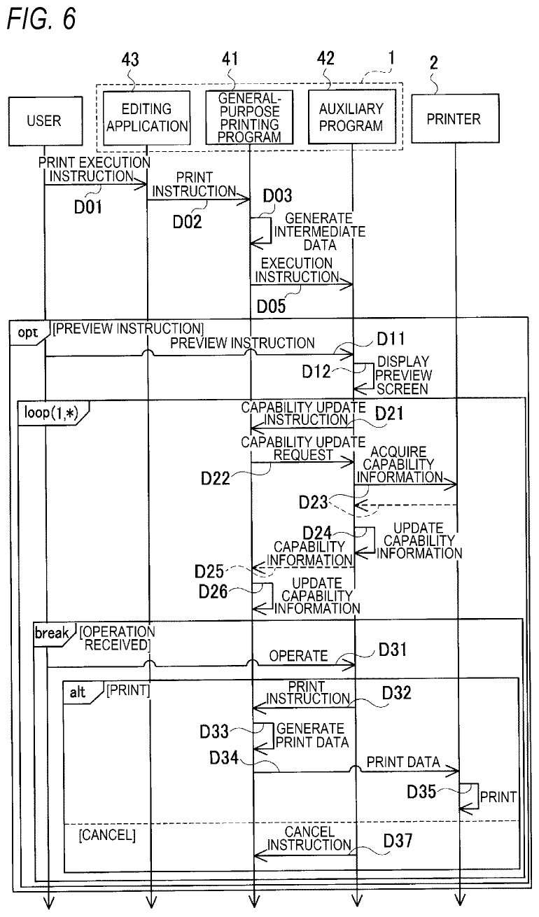

Next, a printing execution procedure will be described with reference to the sequence diagram of FIG. 6. After determining an image to be printed and print settings in the printer 2, a user inputs an instruction for print execution into the editing application 43 (D01). When the editing application 43 receives an instruction for print execution from the user, since the general-purpose printing program 41 is incorporated into the OS 21 of the PC 1, it is determined that an execution instruction to the general-purpose printing program 41 to cause the printer 2 to print the selected image has been received.

The editing application 43 outputs the received print instruction information to the general-purpose printing program 41 (D02). The general-purpose printing program 41 acquires, from the editing application 43, image data indicating an image to be printed and information indicating print settings as information on the print instruction.

The general-purpose printing program 41 generates intermediate data by converting the format of the image data of the image to be printed into the format of the intermediate data based on the information acquired from the editing application 43 (D03). The image data included in the editing application 43 is of various types, and the general-purpose printing program 41 converts the image data to be printed into intermediate data suitable for generating print data. If the image data to be printed is data suitable for generation of the print data, generation of intermediate data may be omitted and the image data may be used as intermediate data as it is.

Before generating the intermediate data, the general-purpose printing program 41 may activate the auxiliary program 42 corresponding to the printer 2, which is the designated device, and notify the auxiliary program 42 that process of the print job has begun. When the auxiliary program 42 is activated from the general-purpose printing program 41, the auxiliary program 42 can pass information indicating various instructions used when generating the intermediate data to the general-purpose printing program 41 as necessary.

After generating the intermediate data, the general-purpose printing program 41 outputs an execution instruction to the auxiliary program 42, thereby activating the auxiliary program 42 (D05). The auxiliary program 42 can acquire the intermediate data generated by the general-purpose printing program 41 by making a request to the general-purpose printing program 41, for example. Further, the auxiliary program 42 can edit the intermediate data or information on the print setting received from the general-purpose printing program 41 as necessary.

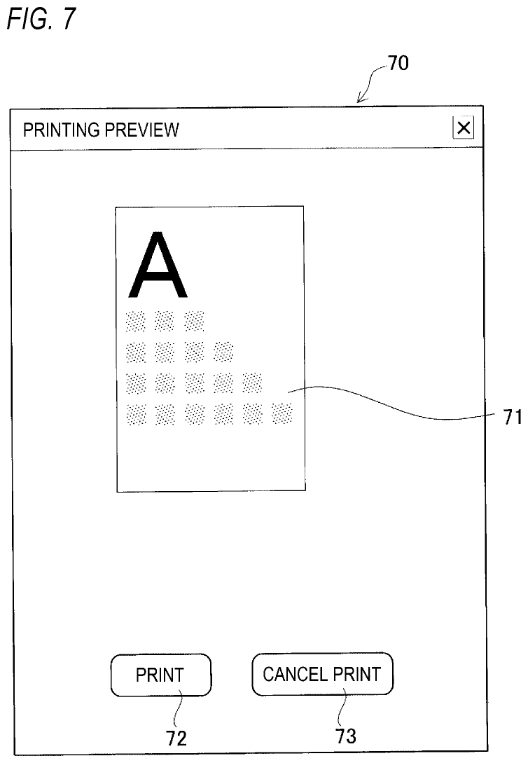

After being activated in D05, the auxiliary program 42 can display a print preview on the user IF 13 based on, for example, a user instruction. When the auxiliary program 42 receives an instruction to display the print preview (opt: [preview instruction], D11), the auxiliary program 42 displays a preview screen 70 including a preview image 71, a “Print” button 72, and a “Cancel Print” button 73, as shown in FIG. 7 (D12). The preview screen 70 is an example of the predetermined screen and an example of the confirmation screen. The process of D12 for displaying the preview screen 70 is an example of the display process.

The preview image 71 is an image showing the image to be printed. The “Print” button 72 is a button for receiving an instruction to continue the process for printing the image currently being displayed. The “Print” button 72 is an example of the operator. The “Cancel Print” button 73 is a button for receiving an instruction to cancel printing. The auxiliary program 42 displays the preview screen 70 including the preview image 71, so that the user can check the print image and instruct to continue the print process.

Note that the reception of a preview instruction from the user (D11) is not essential. That is, the auxiliary program 42 may automatically display the preview screen 70 without receiving the preview instruction. In addition, the screen displayed in D12 may be a preview screen 70 that does not include the preview image 71, as long as it is a screen that receives a confirmation operation from the user. The screen displayed in D12 may be a screen for receiving an input of information required to start printing on the printer 2, such as a screen for receiving user authentication or a screen for receiving PIN input.

When the preview screen 70 is displayed, the auxiliary program 42 does not continue the process for printing unless an operation on the “Print” button 72 is received. The auxiliary program 42 starts a procedure for updating the capability information stored in the memory 12 while the preview screen 70 is displayed and no operation on the buttons 72 and 73 is received.

The auxiliary program 42 outputs a capability update instruction to the general-purpose printing program 41, for example, periodically and repeatedly (loop (1, *)) (D21). As a result, the auxiliary program 42 receives the capability update request from the general-purpose printing program 41 (D22) and acquires the capability information of the printer 2 (D23). D21 to D23 are the same as procedures B11 to B13 in FIG. 3. The process of repeating D21 to D23 is an example of the polling process.

The auxiliary program 42 updates the capability information stored in the memory 12 based on the acquired capability information (D24). Furthermore, the auxiliary program 42 passes the capability information to the general-purpose printing program 41 (D25). This allows the general-purpose printing program 41 to update the capability information indicating the capabilities of the printer 2 (D26).

While the preview screen 70 is displayed, the auxiliary program 42 waits for a user operation. The auxiliary program 42 periodically acquires the capability information of the printer 2 while the preview screen 70 is displayed, so that the latest capability information can be acquired while reducing processing delays. If the capability of printer 2 is changed and the print settings no longer match the capability of the printer 2, the auxiliary program 42 may automatically change the print settings, may be able to receive an instruction to change the print settings, or may display an error message and cancel the printing.

When an operation on the preview screen 70 being displayed is received (break: [operation received], D31), the auxiliary program 42 stops outputting the periodic capability update instruction (D21).

If the user operation is an operation on the “Print” button 72 (alt: [print]), the auxiliary program 42 instructs the general-purpose printing program 41 to rasterize the intermediate data and transmit the raster data, which is the data after rasterization (D32). The general-purpose printing program 41 rasterizes the intermediate data to generate print data (D33), and transmits the generated print data and a print command to the printer 2 (D34). The printer 2 starts printing based on the received print data (D35). D32 is a process for transmitting a print command to the printer 2, and is an example of the print process.

The auxiliary program 42 may perform the rasterization instead of the general-purpose printing program 41. In this case, the auxiliary program 42 may execute rasterization based on the intermediate data to generate print data, pass the generated print data and the print settings to the general-purpose printing program 41, and instruct the general-purpose printing program 41 to transmit the print data and the print settings to the printer 2. The auxiliary program 42 may process the print data generated by the general-purpose printing program 41 or the auxiliary program 42 as necessary. The print data transmitted to the printer 2 may be in any format that can be printed by the printer 2.

When rasterization is performed by the auxiliary program 42, the degree of freedom is higher as compared with the case where rasterization is performed by the general-purpose printing program 41, and print data suitable for printing by the printer 2 is more likely to be generated. On the other hand, when the rasterization is performed by the general-purpose printing program 41, the number of processes of the auxiliary program 42 is reduced, and the program size of the auxiliary program 42 can be reduced.

Further, instead of transmitting the print data from the general-purpose printing program 41 to the printer 2, the auxiliary program 42 may transmit the print data and a print command instructing execution of printing to the printer 2. For example, if the print settings include a setting related to image processing that can be performed by the printer 2, the auxiliary program 42 may generate a print command including information on the processing.

Further, if the user operates the “Cancel Print” button 73 (alt: [cancel]), the auxiliary program 42 instructs the general-purpose printing program 41 to cancel the printing (D37).

As described above in detail, the auxiliary program 42 according to the present aspect causes the CPU 11 of the PC 1 to periodically acquire the capability information from the printer 2 on condition that a predetermined screen for receiving a user operation via the user IF13, such as the detailed setting screen 60 or the preview screen 70, is displayed. Therefore, when the capability of the printer 2 is changed, the auxiliary program 42 or the general-purpose printing program 41 can reflect the changed capability information in the print settings. Thereby, even after the printer 2 is selected, there is a high possibility that a change in the capability of the printer 2 can be accommodated.

The embodiments disclosed in the present specification are merely an example, and does not limit the present invention. Therefore, various improvements and modifications can be naturally made to the technique disclosed in the present specification without departing from the gist of the present invention. For example, the printer 2 connected to the PC 1 is not limited to a single-function printer, but may be any device that has a printing function, such as a multi function device, a copying machine, or a fax machine. The number of printers 2 connected to the PC 1 is not limited to the illustrated example, and may be two or more.

Further, in A31 of the print setting procedure shown in FIG. 2, the auxiliary program 42 stores the acquired capability information, but the acquired capability information may not be stored. When the acquired capability information is stored and there is no possibility that the capability has changed, the auxiliary program 42 can easily use the capability information by reading out the capability information from the memory 12 for use.

In addition, in the procedure shown in FIG. 5, when a change operation is made to a specific item and the output of the periodic capability update instruction is started, if the capability of the printer 2 is changed, the periodic output is stopped, but the aspect is not limited to this. For example, the auxiliary program 42 may continue to output periodically until an instruction to end the detailed print settings is received.

In addition, after the print setting screen is displayed by the general-purpose printing program 41, if the user operates to change a normally used printer from another printer to the printer 2 via the OS 21, the general-purpose printing program 41 may also activate the auxiliary program 42. Furthermore, the auxiliary program 42 may be activated not only when printing is selected, but also when, for example, the printer 2 is selected as a device setting. Even in these cases, the auxiliary program 42 may be able to execute a procedure for updating the capability information.

In the embodiments, although only the printing operations have been described in detail as the operations of the auxiliary program 42, the auxiliary program 42 may also have other roles. The program that executes the process of the present embodiment is not limited to the auxiliary program 42, but may be any program that receives an instruction from the OS 21 or the general-purpose printing program 41 when printing is performed using the general-purpose printing program 41. For example, a print workflow application (Print workflow) whose specifications have been published by Microsoft may be used.

Further, an execution timing of the auxiliary program 42 is not limited to the example of the embodiments. For example, it may be executed in response to a direct execution instruction from the OS 21, or may be a resident auxiliary program 42. If it is resident, the auxiliary program 42 may receive an execution command and perform the above-described operations.

In any flowchart disclosed in the embodiment, an execution order of a plurality of processes in any of a plurality of steps can be freely changed or can be executed in parallel within a range in which no contradiction occurs in a processing content.

The processing disclosed in the embodiments may be executed by hardware such as a single CPU, a plurality of CPU, and an ASIC, or a combination thereof. In addition, the processes disclosed in the embodiments can be implemented in various modes such as a recording medium in which a program for executing the processes is recorded, or a method.

The support program disclosed in the present specification causes the computer of the information processing device to periodically acquire capability information from a printer on condition that a predetermined screen capable of receiving an operation from a user via a user interface of the information processing device is displayed. Therefore, the support program and the general-purpose printing program can reflect the acquired capability information in the print settings. Thereby, even after the printer is selected, there is a high possibility that a change in the capability of the printer can be accommodated.

An information processing device incorporating the support program, a computer-readable storage medium storing the support program, and a control method for implementing a function of the support program are also novel and useful.

The technique disclosed in the present specification implements the technique that can easily accommodate the current capability of a printer in an information processing device in which an OS-standard general-purpose printing program is incorporated.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A non-transitory computer readable storage medium storing a support program that is executable by a computer of an information processing device, corresponds to a printer connected to the information processing device, and supports a general-purpose printing program incorporated in an operating system of the information processing device,
wherein the general-purpose printing program and the support program are configured to cause the computer to receive a print setting for causing the printer to execute printing based on capability information indicating a capability of the printer,
wherein the support program causes the computer to execute a display process of displaying a predetermined screen allowing reception of an operation from a user via a user interface of the information processing device, and
wherein the support program further causes the computer to execute a polling process of periodically acquiring the capability information from the printer when the predetermined screen is being displayed during the display process.

2. The storage medium according to claim 1,
wherein in the polling process, the general-purpose printing program is periodically instructed to update the capability information, and the capability information is acquired from the printer according to the instruction.

3. The storage medium according to claim 1,
wherein at least one of the general-purpose printing program and the support program causes the computer to acquire capability information indicating a capability of the printer through communication with the printer, and store the acquired capability information in a memory of the information processing device,
wherein the general-purpose printing program and the support program causes the computer to receive a print setting for causing the printer to execute printing based on the capability information stored in the memory, and
wherein the support program causes the computer to execute an update process of updating the capability information stored in the memory if there is a change in the capability information acquired this time from the capability information acquired last time while the polling process is being executed, and not to execute the update process if there is no change in the capability information.

4. The storage medium according to claim 1,
wherein the support program causes the computer to execute the display process to display a print setting screen of the support program, which receives a setting operation for a print setting, as the predetermined screen when a display instruction to display the print setting screen is received, and
wherein the support program further causes the computer to execute the polling process when the print setting screen is being displayed.

5. The storage medium according to claim 4,
wherein the support program causes the computer to
start the polling process when a change operation is performed on a specific item corresponding to a capability of the printer that is possibly changed among setting items included in the print setting screen in a state where the polling process is not being executed while the print setting screen is being displayed, and
not start the polling process even if a change operation is performed on an item other than the specific item among the setting items included in the print setting screen in a state where the polling process is not being executed while the print setting screen is being displayed.

6. The storage medium according to claim 5,
wherein the support program causes the computer to stop the polling process if there is a change in the capability information acquired this time from the capability information acquired last time in a state where the print setting screen is being displayed and the polling process is started.

7. The storage medium according to claim 4,
wherein the support program causes the computer to execute a screen update process of updating the print setting screen based on the acquired capability information when the capability information is acquired by the polling process.

8. The storage medium according to claim 1,
wherein the support program causes the computer to execute
when a process is requested from the general-purpose printing program in response to a print instruction to the general-purpose printing program to cause the printer to perform printing,
the display process of displaying a confirmation screen for receiving an operation to continue a process for printing as the predetermined screen, and
the polling process when the confirmation screen is displayed in the display process, and
wherein the support program further causes the computer to execute a print process of transmitting a print command to the printer when the operation to continue the process for printing is received.

9. The storage medium according to claim 8,
wherein in the display process, the confirmation screen, which includes an operator for receiving the operation to continue the process for printing and a preview image showing an image to be printed according to the print instruction, is displayed.
